(19) United States
(12) Patent Application Publication
(10) Pub. No.: US 2020/0292486 A1
(43) Pub. Date: Sep. 17, 2020

(54) SYSTEM AND METHOD FOR IMPROVED BASELINE STABILITY OF ELECTROCHEMICAL SENSOR

(71) Applicant: HONEYWELL INTERNATIONAL INC., Morris Plains, NJ (US)

(72) Inventors: Ling LIU, Morris Plains, NJ (US); Lei XIAO, Morris Plains, NJ (US); Jianming JIN, Morris Plains, NJ (US); Yan ZHANG, Morris Plains, NJ (US); Feng LIANG, Morris Plains, NJ (US)

(21) Appl. No.: 16/760,057

(22) PCT Filed: Nov. 1, 2017
(86) PCT No.: PCT/CN2017/108893

§ 371 Date: Apr. 29, 2020

(51) Int. Cl. G01N 27/413

(52) U.S. Cl. CPC G01N 27/413

(57) ABSTRACT

Embodiments relate generally to systems and methods for operating an electrochemical oxygen sensor at low relative humidity (i.e., 15% RH or less). A method may comprise operating an electrochemical sensor to detect oxygen in the field, wherein the electrochemical sensor comprises one or more electrodes and an electrolyte configured to electrically connect the one or more electrodes with an initial concentration of approximately 8 M sulfuric acid; and maintaining the sensor accuracy during the operation of the sensor to detect oxygen in the field, wherein the relative humidity of the environment is approximately 15% or less, without recalibrating the sensor using a source of nitrogen.

### CROSS-REFERENCE TO RELATED APPLICATIONS

Not applicable.

### STAtEMENT REGARDING FEDERALLY SPONSORED RESEARCH OR DEVELOPMENT

Not applicable.

### REFERENCE TO A MICROFICHE APPENDIX

Not applicable.

### BACKGROUND

Electrochemical gas sensors generally comprise electrodes in contact with an electrolyte for detecting a gas concentration. The electrodes are electrically coupled to an external circuit through contact (or lead) wires that are coupled to connector pins. When a gas contacts the electrolyte and the electrodes, a reaction can occur that can create a potential difference between the electrodes and/or cause a current to flow between the electrodes. The resulting signal can be correlated with a gas concentration in the environment.

In monitoring for the presence of various gases, other gases can be present that can also react within the sensor. For example, the working electrode can comprise a catalyst that can catalyze the reaction of both a target gas and an interferent gas. As a result, the presence of the interferent gas may create a cross-sensitivity in the sensor, resulting in the false impression that greater levels of the target gas are present in the ambient gases than are actually present. Due to the danger presented by the presence of various target gases, the threshold level for triggering an alarm can be relatively low, and the cross-sensitivity due to the presence of the interferent may be high enough to create a false alarm (e.g., false positive) for the target gas sensor. This might be especially true in instances where the interferent gas is not hazardous (meaning that the sensor might trigger an alarm even when exposed to a low level (or even no level) of actually hazardous gas).

### SUMMARY

In an embodiment, a method for operating an electrochemical oxygen sensor may comprise operating an electrochemical sensor to detect oxygen in the field, wherein the electrochemical sensor comprises one or more electrodes and an electrolyte configured to electrically connect the one or more electrodes with an initial concentration of approximately 8 M sulfuric acid; and maintaining the sensor accuracy during the operation of the sensor to detect oxygen in the field, wherein the relative humidity of the environment is approximately 15% or less, without recalibrating the sensor using a source of nitrogen.

In an embodiment, an electrochemical sensor may comprise a housing; one or more electrodes located within the housing; and an electrolyte deposited within the housing configured to electrically connect the one or more electrodes, wherein the electrolyte comprises an initial concentration of approximately 8 M sulfuric acid, wherein the sensor is configured to detect oxygen in an environment with a relative humidity of approximately 15% or less without recalibrating the sensor using a source of nitrogen.

In an embodiment, a method for retrofitting an existing electrochemical sensor may comprise providing an electrochemical sensor comprising a housing and one or more electrodes; and depositing an electrolyte within the housing, wherein the electrolyte is configured to electrically connect the one or more electrodes, and wherein the electrolyte comprises an initial concentration of approximately 8 M sulfuric acid.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a cross section drawing of an electrochemical sensor according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for improving the operation of an electrochemical sensor, particularly in low humidity environments. Typical gas detectors that employ one or more electrochemical sensors may require calibration to achieve accurate sensor readings. As an example, an oxygen (O₂) sensor may need to be calibrated if the observed O₂ reading is not 20.9%. Calibration may be performed manually or using an automatic test and calibration system. In general, calibration involves calibrating with pure nitrogen gas (N₂) (i.e., a zero O₂ reading) and calibrating with 20.9% oxygen. N₂ calibration would typically require the gas detector to be attached to a source of nitrogen gas, such as a bottle of the gas. 20.9% O₂ calibration could be accomplished using ambient (e.g., fresh) air.

These calibration steps, particularly with N₂, may be difficult and costly for a user to perform after the gas detector has been employed by the user. To prevent the need for calibration after the gas detector is employed by the user, disclosed embodiments may provide a gas detector with a stable signal that is independent of changes in temperature and/or humidity. When the humidity of the environment changes, especially in low humidity, typical oxygen sensors may experience a baseline drift, requiring the gas detector (and oxygen sensors) to be re-calibrated. Low humidity environments may comprise approximately 15% relative humidity (RH) or less.

Operationally, at a working (or sensing) electrode of an electrochemical sensor, the O₂ is reduced, according to the following equation:

O₂4H⁺+4e⁻→2H₂O (1)

At a counter electrode of the electrochemical sensor, there is a counter balancing oxidation, according to the following equation:

2H₂O→4H⁺+O₂+4e⁻ (2)

The signal of the sensor may be generated by the O₂ reacting at the working electrode. O₂ may contact the working electrode via an inlet to the sensor, and O₂ may in some cases contact the working electrode via back diffusion from the counter electrode and/or an outlet of the sensor. An electrolyte of the electrochemical sensor may be configured to prevent back diffusion of O₂ from the counter electrode and the outlet.

In some typical electrochemical sensors, the electrolyte may be balanced to typical environmental conditions (e.g., approximately 25° C. and approximately 50% RH). As an example, 6 molar (M) sulfuric acid (H₂SO₄) may be used as the electrolyte. Under normal operation, when the environment humidity increases, the electrolyte may adsorb water, and when the environment humidity decreases, the electrolyte may lose water. When the sensor is exposed to low humidity, the electrolyte volume will decrease due to the evaporation of water, causing the distribution of the electrolyte within the sensor to change. Additionally, the resistance of the electrolyte to O₂ back diffusion (from the counter electrode and/or outlet of the sensor) may decrease with the decrease in volume, causing a shift in the baseline signal of the sensor (requiring re-calibration). Because of this back diffusion of O₂, typical electrochemical sensors may suffer from a shifted baseline signal during and after operation at low relative humidity, such as RH 15% or less.

Embodiments of the disclosure include systems and methods for improving the resistance of the electrolyte to O₂ back diffusion. In an exemplary embodiment, the electrolyte volume at low humidity may be increased by increasing the initial concentration of sulfuric acid from approximately 6 M to approximately 8 M. This may be equivalent to a 33% volume increase when compared to a typical 6 M sulfuric acid electrolyte, which may represent a 33% increase in the resistance of the electrolyte to O₂ back diffusion. The electrolyte comprising an increased concentration of sulfuric acid (i.e., 8 M sulfuric acid) may successfully operate at a range of humidity conditions, such as, for example, 10% RH to 95% RH. The signal of the oxygen sensor comprising the electrolyte may be stable at this range of humidity conditions. The signal of the oxygen sensor may be particularly resistant to shifting at low humidity conditions (e.g., 15% RH or less).

The described embodiments may provide improved oxygen sensing in low humidity environments. When an oxygen sensor is only needed to operate in a normal humidity environment (i.e., higher than 15% RH), the electrolyte volume increase caused by increasing the concentration of the electrolyte (e.g., from 6 M sulfuric acid to 8 M sulfuric acid) may not have historically been desirable, as the gas detector and electrochemical sensor have limited internal volume(s) (e.g., due to the miniature size of the detector and/or sensor). However, when the sensor is employed in low humidity environments (even temporarily), the volume increase may be desirable to prevent the O₂ back diffusion. Additionally, the volume increase may not negatively affect the operation of the sensor at humidity levels higher than 15% RH.

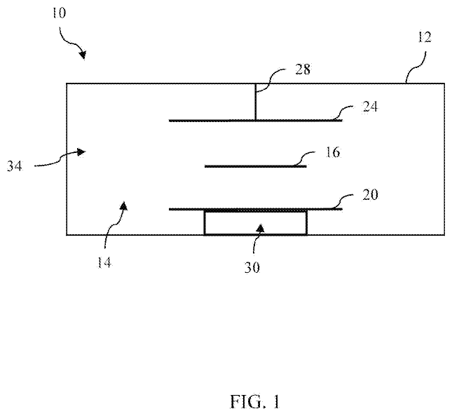

FIG. 1 illustrates the cross section drawing of an electrochemical sensor 10. The sensor 10 generally comprises a housing 12 defining a cavity or reservoir 14 designed to hold an electrolyte solution 34. A working (or sensing) electrode 24 may be positioned within the reservoir 14 and adjacent to an opening 28 in the housing 12 (where one or more walls of the housing 12 may define the reservoir 14). The opening 28 may comprise a capillary opening. A counter electrode 16 and a reference electrode 20 can be positioned within the reservoir 14. When gas (e.g., oxygen) reacts within the reservoir 14 (e.g., at the interface between the working electrode 24 and the electrolyte 34), an electrical current and/or potential can be developed between the electrodes to provide an indication of the concentration of the gas. A reference electrode 20 may also be positioned within the reservoir 14 to provide a reference for the detected current and potential between the working electrode 24 and the counter electrode 16. The reference electrode 20 may also be configured to provide a reference for the potential of the working electrode 24 relative to a standard reference electrode, such as a reversible hydrogen electrode.

FIG. 1 illustrates an example of a “stacked” configuration for an electrochemical sensor 10. The embodiments disclosed herein may also apply to other sensor configurations, such as a planar configuration and/or other stacked configurations.

The housing 12 defines the interior reservoir 14, and one or more openings 28 can be disposed in the housing 12 to allow a target gas to enter the housing 12 into a gas space. The housing 12 can generally be formed from any material that is substantially inert to the electrolyte and target gas being measured. In an embodiment, the housing 12 can be formed from a polymeric material, a metal, or a ceramic. For example, the housing 12 can be formed from a material including, but not limited to, acrylonitrile butadiene styrene (ABS), polyphenylene oxide (PPO), polystyrene (PS), polypropylene (PP), polyethylene (PE) (e.g., high density polyethylene (HDPE)), polyphenylene ether (PPE), or any combination or blend thereof.

One or more openings 28 and 30 can be formed through the housing 12 to allow the ambient gas to enter the reservoir 14 and/or allow any gases generated within the housing 12 to escape. In the embodiment shown in FIG. 1, the one or more opening may comprise an inlet 28 and an outlet 30. The openings(s) 28 and 30 can be disposed in a cap (e.g., when a cap is present) and/or in a wall of the housing 12. In some embodiments, the opening(s) 28 and 30 can comprise a diffusion barrier to restrict the flow of gas (e.g., oxygen, nitrogen, etc.) to the working electrode 24. The diffusion barrier can be created by forming the opening 28 as a capillary and/or a film or membrane that can be used to control the mass flow rate through the one or more openings 28 and 30.

In an embodiment, the inlet 28 may serve as a capillary opening to provide a rate limited exchange of the gases between the interior and exterior of the housing 12. In an embodiment, the opening(s) 28 and/or 30 may have a diameter between about 10 μm and about 1.5 mm, where the opening(s) 28 and/or 30 can be formed using a conventional drill for larger openings and a laser drill for smaller openings. In another embodiment, the opening(s) 28 and/or 30 may be much larger, where the opening(s) 28 and/or 30 may comprise any diameter up to the total diameter of the housing 12. The opening(s) 28 and/or 30 may have a length between about 0.5 mm and about 5 mm, depending on the thickness of the cap or housing 12. When a membrane is used to control the gas flow into and/or out of the housing, the opening diameter may be larger than the sizes listed above as the film can contribute to and/or may be responsible for controlling the flow rate of the gases into and out of the housing 12.

In FIG. 1, the reservoir 14 may comprise (or contain) the counter electrode 16, the reference electrode 20, and the working electrode 24. In some embodiments, the electrolyte 34 can be contained within the reservoir 14, and the counter electrode 16, the reference electrode 20, and the working electrode 24 can be in electrical contact through the electrolyte 34. In some embodiments, one or more porous separators or other porous structures can be used to retain the electrolyte 34 in contact with the electrodes.

The electrolyte 34 can be any conventional aqueous acidic electrolyte such as sulfuric acid (H₂SO₄), phosphoric acid, or any combination thereof. For example, the electrolyte 34 can comprise sulfuric acid having a molar concentration of about 8 M. Since sulfuric acid is hygroscopic, the concentration can vary from about 10 to about 70 wt % (1 to 11.5 molar) over a relative humidity (RH) range of the environment of about 3 to about 95%.

In some embodiments, the electrolyte 34 may be in the form of a solid polymer electrolyte which comprises an ionic exchange membrane. In some embodiments, the electrolyte 34 can be in the form of a free liquid, disposed in a matrix or slurry such as glass fibers, or disposed in the form of a semi-solid or solid gel.

The working electrode 24 may be disposed within the housing 12. The gas entering the sensor 10 can contact one side of the working electrode 24 and pass through working electrode 24 to reach the interface between the working electrode 24 and the electrolyte 34. The gas can then react to generate the current indicative of the target gas concentration. As disclosed herein, the working electrode 24 can comprise a plurality of layers. The base or substrate layer can comprise a hydrophobic material or a hydrophobically treated material. A catalytic material can be formed as an electrode on one side of the working electrode 24 and placed in contact with the electrolyte 34.

In an embodiment, the working electrode 24 can comprise a porous substrate or membrane as the base layer. The substrate can be porous to the gas of interest, which may comprise oxygen. In an embodiment, the substrate can comprise a carbon paper formed of carbon or graphite fibers. In some embodiments, the substrate can be made to be electrically conductive through the addition of a conductive material such as, for example, carbon. The use of carbon may provide a sufficient degree of electrical conductivity to allow the current generated by the reaction of the gas with the electrolyte 34 at the surface of the working electrode 24 to be detected by a contact coupled to the working electrode 24 (e.g., where the contact may comprise a platinum material). Other electrically conductive substrates may also be used such as carbon felts, porous carbon boards, and/or electrically conductive polymers such as, for example, polyacetylene, each of which may be made hydrophobic as described below. Alternatively, an electrically conductive contact (e.g., which may comprise a platinum material) can be coupled to the catalytic layer to electrically couple the catalytic material to the external circuitry, as described in more detail herein. In an embodiment, the substrate can be between about 5 mils to about 20 mils thick in some embodiments.

The porous substrate can be hydrophobic to prevent the electrolyte 34 from passing through the working electrode 24. The substrate can be formed from a hydrophobic material, or the substrate can be treated with a hydrophobic material. In an embodiment, the substrate can be made hydrophobic through the impregnation of the substrate with a hydrophobic material such as a fluorinated polymer (e.g., PTFE, etc.). In some embodiments, the substrate or membrane can comprise GEFC-IES (e.g., the copolymer of perfluorosulfonic acid and PTFE, which is commercially available from Golden Energy Fuel Cell Co., Ltd.), Nafion® (a copolymer of polytetrafluoroethylene and perfluoro-3,6-dioxa-4-methyl-7-octene-sulfonic acid, which is commercially available from Dupont®), or pure or nearly pure polytetrafluoroethylene (PTFE). The impregnation process can include disposing a hydrophobic material containing solution or slurry on the substrate using a dipping, coating, or rolling process. Alternatively, a dry composition such as a powder can be applied to the substrate. In some embodiments, an optional sintering process can be used to infuse the hydrophobic material into the substrate to create the hydrophobic base layer for the working electrode 24, where both sides of the hydrophobic base layer are hydrophobic. The sintering process can cause the hydrophobic polymer to bond or fuse with the carbon of the substrate to securely bond the hydrophobic material to the substrate.

The resulting substrates can contain about 30% to about 50% by weight of the hydrophobic polymer. The amount of hydrophobic material added to the substrate can affect the electrical conductivity of the substrate, wherein the electrical conductivity tends to decrease with an increased amount of the hydrophobic material. The amount of the hydrophobic polymer used with the substrate may depend on the degree of hydrophobicity desired, the porosity of the oxygen, and the resulting electrical conductivity of the working electrode.

The catalytic layer can be formed by mixing the desired catalyst with a binder and depositing the mixture on the substrate material. The binder can comprise a solution of perfluorinated ion electrolyte solution (e.g., GEFC-IES, Nafion®, etc.), a hydrophobic material such as PTFE, mixtures thereof, or the like. When used as a binder, the GEFC-IES Nafion®, and/or PTFE can affect the gas diffusion parameters while supporting the electrocatalyst and maximizing the interfaces between catalyst, gas and electrolyte at which the electrochemical processes occur. Glycol or other similar chemicals can be used as a diluent to form a catalyst slurry, recipe or catalyst system, which can be printed on a substrate by a printer.

The catalytic layer might be deposited onto the substrate, for example, by screen printing, filtering in selected areas from a suspension placed onto the substrate, by spray coating, or any other method suitable for producing a patterned deposition of solid material. Deposition might be of a single material or of more than one material sequentially in layers, so as for example to vary the properties of the electrode material through its thickness or to add a second layer of increased electrical conductivity above or below the layer which is the main site of gas reaction. Once deposited, the printed element can be sintered at an elevated temperature to form the electrode.

In the working electrode 24, the catalytic layer can comprise carbon (e.g., graphite) and/or one or more metals such as palladium, platinum, ruthenium, and/or iridium. In an embodiment of the sensor 10, the working electrode 24 may comprise platinum. The catalyst used can be a pure metal powder, a metal powder combined with carbon, or a metal powder supported on an electrically conductive medium such as carbon, or a combination of two or more metal powders either as a blend or as an alloy. The materials used for the individual electrodes can be the same or different.

The counter electrode 16 can comprise a substrate or membrane such as a PTFE membrane, a GEFC-IES membrane, a Nafion® membrane, or the like having a catalytic material disposed thereon. In an embodiment, the catalytic material can be mixed and disposed on the membrane using any suitable process such as rolling, coating, screen printing, or the like to apply the catalytic material on the membrane, as described in more detail herein. The catalyst layer can then be bonded to the membrane through a sintering process as described herein.

In an embodiment, the catalytic material for the counter electrode 16 can comprise a noble metal such as platinum (Pt), ruthenium (Ru), rhodium (Rh), iridium (Ir), or any combination thereof. The catalyst loading for the counter electrode 16 can be within any of the ranges described herein for the working electrode 24. In an embodiment, the catalyst loading for the counter electrode 16 can be the same or substantially the same as the catalyst loading for the working electrode 24, the catalyst loading can also be greater than or less than that of the working electrode 24.

Similarly, the reference electrode 20 can comprise a substrate or membrane such as a PTFE membrane, a GEFC-IES membrane, a Nafion® membrane, or the like having a catalytic material disposed thereon. In an embodiment, the catalytic material can be mixed with a hydrophobic material (e.g., PTFE, etc.) and disposed on the PTFE membrane. Any of the methods used to form the working electrode or the counter electrode can also be used to prepare the reference electrode 20. In an embodiment, the catalytic material used with the reference electrode 20 can comprise a noble metal such as platinum (Pt), ruthenium (Ru), rhodium (Rh), iridium (Ir), or any combination thereof. The catalyst loading for the reference electrode 20 can be within any of the ranges described herein for the working electrode 24. In an embodiment, the catalyst loading for the reference electrode 20 can be the same or substantially the same as the catalyst loading for the working electrode 24, the catalyst loading can also be greater than or less than that of the working electrode 24. While illustrated in FIG. 1 as having the reference electrode 20, some embodiments of the electrochemical sensor 10 may not include a reference electrode 20.

In order to detect the current and/or potential difference across the electrodes in response to the presence of the oxygen, one or more electrical contacts (or leads) can be electrically coupled to the working electrode 24, the reference electrode 20, and/or the counter electrode 16. The contact contacting the working electrode 24 can contact either side of the working electrode 24 since the substrate comprises an electrically conductive material. Contacts may be similarly electrically coupled to the counter electrode 16 and the reference electrode 20. The contacts can be electrically coupled to external connection pins to provide an electrical connection to external processing circuitry. The external circuitry can detect the current between the electrodes and convert the current into a corresponding oxygen concentration (by, for example, comparison to a pre-existing table/database which correlates current and/or potential difference to gas level, for example based on prior testing).

In use, the ambient gas can flow or diffuse into the sensor 10 through the opening 28, which serves as the intake port for the sensor 10. The ambient gas can comprise oxygen. The gas can contact the working electrode and pass through the fine pores of the porous substrate layer to reach the surface of the working electrode 24 treated with the catalyst layer. The electrolyte may be in contact with the surface of the working electrode 24, and the oxygen may react and result in an electrolytic current forming between the working electrode 24 and the counter electrode 16 that corresponds to the concentration of the oxygen in the ambient gas. By measuring the current, the concentration of oxygen can be determined using, for example, the external detection circuitry.

Some embodiments of the disclosure may comprise a method for operating an electrochemical oxygen sensor, where the sensor may comprise an initial electrolyte concentration of approximately 8 M sulfuric acid. An exemplary method may comprise providing a sensor comprising one or more electrodes and an 8 M sulfuric acid electrolyte configured to electrically connect the one or more electrodes. The sensor may be initially calibrated (e.g., before use in the field) using a source of nitrogen (i.e., no oxygen) to set the zero baseline for the oxygen sensor. In some embodiments, the sensor may also be calibrated (before use in the field) using fresh (or ambient) air, which may comprise approximately 20.9% oxygen.

A method may also comprise operating the sensor to detect oxygen in the field, where the relative humidity of the environment is approximately 15% or less. A method may also comprise maintaining the sensor accuracy during the operation of the sensor to detect oxygen in the field, where the relative humidity of the environment is approximately 15% or less, without recalibrating the sensor using a source of nitrogen (i.e., the sensor may be operated in a low humidity environment without the need for recalibration). In some embodiments, the sensor may be operated to detect oxygen in the field, where the relative humidity of the environment is approximately 10% or less. In some embodiments, the sensor may be operated to detect oxygen with an accuracy within ±0.1% O₂, despite operation at a relative humidity of approximately 15% or less. In some embodiments, the sensor may require no recalibration using a source of nitrogen during the life of the sensor, despite operation of the sensor in an environment with a relative humidity of approximately 15% or less.

Embodiments may also include a method of retrofitting an existing electrochemical sensor with an electrolyte comprising an initial concentration of approximately 8 M sulfuric acid (where the existing sensor may typically comprise less than 8 M sulfuric acid). In a method of retrofitting, providing the electrochemical sensor may comprise applying an electrolyte to an existing sensor, where the electrolyte comprises a concentration of approximately 8 M sulfuric acid.

In some cases, an existing sensor structure may be used with a change in electrolyte concentration. The change may be made without the need to reconfigured the preexisting sensor design, including sizes, materials, layout, etc.

Having described various devices and methods herein, exemplary embodiments or aspects can include, but are not limited to:

In a first embodiment, a method for operating an electrochemical oxygen sensor may comprise operating an electrochemical sensor to detect oxygen in the field, wherein the electrochemical sensor comprises one or more electrodes and an electrolyte configured to electrically connect the one or more electrodes with an initial concentration of approximately 8 M sulfuric acid; and maintaining the sensor accuracy during the operation of the sensor to detect oxygen in the field, wherein the relative humidity of the environment is approximately 15% or less, without recalibrating the sensor using a source of nitrogen.

A second embodiment can include the method of the first embodiment, further comprising operating the sensor to detect oxygen in the field, wherein the relative humidity of the environment is approximately 10% or less.

A third embodiment can include the method of the first or second embodiments, further comprising operating the sensor to detect oxygen with an accuracy within ±0.1% oxygen, despite operation at a relative humidity of approximately 15% or less.

A fourth embodiment can include the method of any of the first through third embodiments, wherein the sensor requires no recalibration using a source of nitrogen during the life of the sensor, despite operation of the sensor in an environment with a relative humidity of approximately 15% or less.

A fifth embodiment can include the method of any of the first through fourth embodiments, further comprising providing the electrochemical sensor comprising the one or more electrodes and the electrolyte comprising an initial concentration of approximately 8 M sulfuric acid.

A sixth embodiment can include the method of the fifth embodiment, wherein providing the electrochemical sensor comprises retrofitting an existing electrochemical sensor with the electrolyte comprising an initial concentration of approximately 8 M sulfuric acid.

A seventh embodiment can include the method of the fifth or sixth embodiments, wherein retrofitting and existing electrochemical sensor comprises providing an electrochemical sensor comprising a housing and one or more electrodes; applying an electrolyte within the housing, wherein the electrolyte is configured to electrically connect the one or more electrodes, and wherein the electrolyte comprises an initial concentration of approximately 8 M sulfuric acid.

An eighth embodiment can include the method of any of the first through seventh embodiments, further comprising initially calibrating the electrochemical sensor using a source of nitrogen, without any oxygen, to set a zero baseline for the electrochemical sensor.

A ninth embodiment can include the method of any of the first through eighth embodiments, further comprising initially calibrating the electrochemical sensor using air comprising approximately 20.9% oxygen.

A tenth embodiment can include the method of any of the first through ninth embodiments, further comprising maintaining the sensor accuracy after the operation of the sensor in an environment with a relative humidity of approximately 15% or less.

In an eleventh embodiment, an electrochemical sensor may comprise a housing; one or more electrodes located within the housing; and an electrolyte deposited within the housing configured to electrically connect the one or more electrodes, wherein the electrolyte comprises an initial concentration of approximately 8 M sulfuric acid, wherein the sensor is configured to detect oxygen in an environment with a relative humidity of approximately 15% or less without recalibrating the sensor using a source of nitrogen.

A twelfth embodiment can include the electrochemical sensor of the eleventh embodiment, wherein the one or more electrodes comprise a working electrode configured to reduce oxygen that enters the sensor via an opening in the housing.

A thirteenth embodiment can include the electrochemical sensor of the twelfth embodiment, wherein the one or more electrodes comprise a counter electrode configured to provide a chemical balance to the working electrode and oxidize water to produce oxygen.

A fourteenth embodiment can include the electrochemical sensor of the thirteenth embodiment, wherein the electrolyte is configured to prevent oxygen produced at the counter electrode from reacting at the working electrode.

A fifteenth embodiment can include the electrochemical sensor of any of the eleventh through fourteenth embodiments, wherein the electrochemical sensor is configured to be initially calibrated with nitrogen before use in the field.

In a sixteenth embodiment, a method for retrofitting an existing electrochemical sensor may comprise providing an electrochemical sensor comprising a housing and one or more electrodes; and depositing an electrolyte within the housing, wherein the electrolyte is configured to electrically connect the one or more electrodes, and wherein the electrolyte comprises an initial concentration of approximately 8 M sulfuric acid.

A seventeenth embodiment can include the method of the sixteenth embodiment, further comprising operating the electrochemical sensor to detect oxygen in an environment with a relative humidity of 15% or less, without recalibrating the electrochemical sensor using a source of nitrogen.

An eighteenth embodiment can include the method of the seventeenth embodiment, further comprising maintaining the accuracy of the sensor during and after operating the electrochemical sensor to detect oxygen in an environment with a relative humidity of 15% or less.

A nineteenth embodiment can include the method of any of the sixteenth through eighteenth embodiments, further comprising operating the electrochemical sensor to detect oxygen without changing the specifications of the existing sensor.

A twentieth embodiment can include the method of any of the sixteenth through nineteenth embodiments, further comprising, before operating the electrochemical sensor, initially calibrating the sensor using nitrogen to establish a zero baseline for the sensor.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically, and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for operating an electrochemical oxygen sensor, the method comprising:
operating an electrochemical sensor to detect oxygen in the field, wherein the electrochemical sensor comprises one or more electrodes and an electrolyte configured to electrically connect the one or more electrodes with an initial concentration of approximately 8 M sulfuric acid; and
maintaining the sensor accuracy during the operation of the sensor to detect oxygen in the field, wherein the relative humidity of the environment is approximately 15% or less, without recalibrating the sensor using a source of nitrogen.

2. The method of claim 1, further comprising operating the sensor to detect oxygen in the field, wherein the relative humidity of the environment is approximately 10% or less.

3. The method of claim 1, further comprising operating the sensor to detect oxygen with an accuracy within ±0.1% oxygen, despite operation at a relative humidity of approximately 15% or less.

4. The method of claim 1, wherein the sensor requires no recalibration using a source of nitrogen during the life of the sensor, despite operation of the sensor in an environment with a relative humidity of approximately 15% or less.

5. The method of claim 1, further comprising providing the electrochemical sensor comprising the one or more electrodes and the electrolyte comprising an initial concentration of approximately 8 M sulfuric acid.

6. The method of claim 5, wherein providing the electrochemical sensor comprises retrofitting an existing electrochemical sensor with the electrolyte comprising an initial concentration of approximately 8 M sulfuric acid.

7. The method of claim 6, wherein retrofitting and existing electrochemical sensor comprises:
providing an electrochemical sensor comprising a housing and one or more electrodes;
applying an electrolyte within the housing, wherein the electrolyte is configured to electrically connect the one or more electrodes, and wherein the electrolyte comprises an initial concentration of approximately 8 M sulfuric acid.

8. The method of claim 1, further comprising initially calibrating the electrochemical sensor using a source of nitrogen, without any oxygen, to set a zero baseline for the electrochemical sensor.

9. The method of claim 1, further comprising initially calibrating the electrochemical sensor using air comprising approximately 20.9% oxygen.

10. The method of claim 1, further comprising maintaining the sensor accuracy after the operation of the sensor in an environment with a relative humidity of approximately 15% or less.

11. An electrochemical sensor (10) comprising:
a housing (12);
one or more electrodes (16, 20, 14) located within the housing (12); and
an electrolyte (34) deposited within the housing (12) configured to electrically connect the one or more electrodes (16, 20, 24), wherein the electrolyte (34) comprises an initial concentration of approximately 8 M sulfuric acid, wherein the sensor (10) is configured to detect oxygen in an environment with a relative humidity of approximately 15% or less without recalibrating the sensor (10) using a source of nitrogen.

12. The electrochemical sensor (10) of claim 11, wherein the one or more electrodes comprise a working electrode (24) configured to reduce oxygen that enters the sensor (10) via an opening (28) in the housing (12).

13. The electrochemical sensor (10) of claim 12, wherein the one or more electrodes comprise a counter electrode (16) configured to provide a chemical balance to the working electrode (24) and oxidize water to produce oxygen.

14. The electrochemical sensor (10) of claim 13, wherein the electrolyte (34) is configured to prevent oxygen produced at the counter electrode (16) from reacting at the working electrode (24).

15. The electrochemical sensor (10) of claim 11, wherein the electrochemical sensor (10) is configured to be initially calibrated with nitrogen before use in the field.
